(19) United States
(12) Patent Application Publication
(10) Pub. No.: US 2001/0052179 A1
(43) Pub. Date: Dec. 20, 2001

(54) Coiling apparatus

(75) Inventors: Peter Hugh Dickinson, Cardiff (GB); Barry Lewis, Bridgend (GB)

Correspondence Address: YOUNG & THOMPSON, 745 SOUTH 23RD STREET 2ND FLOOR, ARLINGTON, VA, 22202

(73) Assignee: Spectrum Technologies PLc

(21) Appl. No.: 09/921,693

(22) Filed: Aug. 6, 2001

Related U.S. Application Data
(63) Continuation of application No. PCT/GB00/00318, filed on Feb. 4, 2000.

(30) Foreign Application Priority Data
Feb. 4, 1999 (GB) 9902382.2

(51) Int. Cl. B23P 23/00; B23Q 41/00

(52) U.S. Cl. 29/564; 29/564.6

(57) ABSTRACT

In a coiling apparatus for measuring cutting and optionally marking a succession of lengths of an elongate flexible such as wire or cable, the leading edge of each of the elements are clamped in the same angular position in a rotary coiling assembly.

This means that on completion of a set of coils, they may be removed from the coiling assembly with each of their leading edges aligned for further processing, e.g. by attachment of a multiple connector.

This invention relates to coiling apparatus and in particular but not exclusively to coiling apparatus for collecting wire or fibres marked measured and cut by a marking apparatus. In other applications, for example, the coiling apparatus could be used to coil material which is simply measured and cut.

Wires used in the manufacture of electrical wiring harnesses (sub-systems) e.g. as used in the aerospace industry, are typically initially processed on a machine which is programmed to mark the wires with the appropriate coding (e.g. alphanumeric or bar coding), to measure them and to cut them to the required length. At the output of these machines the wire is usually collected in a coiling pan. This is a simple powered or unpowered rotary receptacle, which collects the wire and presents it in a coiled form to the operator for removal by hand. Typical diameters of coiling pans vary between 6 inches and 15 inches (approx 15 cm and 40 cm).

Previous wire processing systems, mostly based on ink marking technology, suffer from disadvantages in terms of set up times, which preclude the development of automated wire processing capabilities. This tends to mean that separate batches of wires of a particular type are processed singly and subsequently the wires from the batches then separated and sorted by hand in a downstream operation into the various groups of wires related to individual connectors, which go to make up the wiring system. With the advent of more modern wire processing systems and in particular laser wire marking systems, as developed and manufactured by the Applicant, the set up times required to change wire type on the wire processing system has been considerably shortened. It is now possible therefore to process wires “by connector”. In this situation all the different types of wire required for an individual connector are processed in sequence, i.e. the machine does the sorting.

Up to now, the wire has typically been collected in coiling pans so that, even when the wires are processed by connector instead of in batches, the wires are usually removed one at a time as they are processed. It should be noted that the wire ends need to be grouped together by the machine operator, so that when the downstream harness assembly operator receives the processed wires, all the wire ends are conveniently grouped together for further processing (stripping, crimping and pin insertion into the connector). The grouping together takes time and skill on the part of the operator.

One attempt to overcome this problem comprises a linear stacker unit which is a linear wire collection system incorporating a conveyor belt and a trough into which processed wires are deposited. The key advantage of this linear stacker unit is that, as wires exit the wire marking machine and are transferred down the conveyor belt, the trailing ends of the wire can all be grouped together at the same point in the trough. The operator then typically removes the whole bundle of wires, holding the grouped wired ends together, and then coils and ties the whole group to provide the wires ready for downstream processing. For shorter wire lengths, e.g. a few meters, this is a practical solution, however, many wires used in electrical harnesses can be of considerable length, particularly those used in e.g. the aerospace and locomotive industry where wire lengths may be up to 60 meters of more. It is clearly impractical to have a 60 meter long stacking system for collecting the wires in this case.

U.S. Pat. No. 3,895,763 describes an arrangement in which the cable is marked and fed to a power driven coiling pan. The coils produced in this way are placed on a holding jig until all the wires in the required group have been marked, cut and coiled. The trailing ends of the wires are collected manually and secured in a clamp fixture, and a connector may then be applied. This operation takes at least two stages and requires manual collection of the ends of the wires.

Accordingly, in one aspect, this invention provides a coiling apparatus for collecting in coiled form a plurality of successive elongate flexible elements, such as e.g. a wire or fibre, paid out from an upstream location, said coiling apparatus comprising a rotary coiling member mounted for rotation about an axis and adapted in use to receive a succession of said elongate flexible members and to rotate to cause each of said elongate flexible members to be coiled within or about said rotary coiling member, said rotary coiling member including location means for locating said elongate flexible elements such that respective one ends thereof are grouped at a preset location with respect to said rotary coiling member.

This arrangement provides a simple means whereby a succession of elongate flexible elements of different types and lengths may be paid out and coiled into or around said coiling member with respective one ends of the wires grouped together, thereby obviating the need for manual sorting before the wires are passed to an operator for making up a connector. Unlike the case with the linear stacker unit, the rotary nature of the device of this invention means that the size, complexity and cost are not primarily determined by the maximum linear lengths of the wires to be processed.

Said location means may take many forms, but a simple and preferred arrangement is for the location means to locate respective leading ends of the wires at a preset location with respect to the rotary coiling member. In one embodiment, the location means comprises an abutment surface or collection region disposed within the rotary coiling member against or into which the leading ends of successive elongate flexible elements engage on approaching the rotary coil member. Said location means my typically comprise wall surfaces defining a blind channel into which the leading ends of each of a succession of elongate members may pass to be grouped together thereby.

By this arrangement, in a wire or fibre marking machine a rotary coiling member may collect together a succession of wires or fibres for making up a connector, thus providing a major benefit in terms of automation of the process. Time is saved on the wire or fibre processing machine as the operator does not have to take time out to remove each individual wire after it is processed to enable the wire ends to be collected together, thereby increasing productivity of the machine.

The rotary coiling member may take many forms; for example it may comprise a mandrel means on which the elongate flexible elements are wound. In a preferred embodiment it may comprise a coiling pan means arranged generally concentrically with respect to said mandrel means to define therewith a substantially annular void within which in use said flexible elements may coil. The coiling pan means preferably comprises a plurality of wall sections defining an interrupted generally cylindrical wall, and is preferably rotationally fixed with respect to said mandrel means. Said location means is preferably associated with the coiling pan means.

Preferably the apparatus further includes means for ensuring in use that, for each elongate flexible element, the abutment surface or collection region is in a substantially aligned position to receive the leading end thereof as it approaches the rotary coiling member. Thus the apparatus preferably includes means for moving the pan means into angular registration with a datum before the leading end engages the rotary coiling member. The apparatus preferably includes drive means for rotating said rotary coiling member to effect coiling in use of said elongate flexible elements. The drive means preferably is also operable to align the rotary coiling member, although a separate alignment device may be used. Preferably said drive means is operable to apply a limited torque to said rotary coiling member, thereby to allow slippage of the rotary coiling member relative to said drive means.

To allow for management of the flexible elements, the apparatus preferably includes first clamp means operable to clamp the elongate flexible elements at or adjacent their respective one ends at said present location with respect to said rotary coiling member. The first clamp means is preferably fixed with respect to said rotary coiling member and rotates therewith. The apparatus preferably also includes a relatively fixed further clamp means which remains rotationally stationary on rotation of said rotary coiling member and which is operable to clamp the elongate flexible elements at or adjacent their respective one end regions during a loading routine when the rotary coiling member is stationary and the first clamp means is relaxed.

In another embodiment said rotary coiling member may comprise a coiling pan means into which the elongate flexible element may be coiled. The segregating means may comprise means for depositing in use a divider member into the pan means on top of a group of elongate flexible members.

Said location means may typically comprise wall surfaces defining a blind channel into which the leading ends of each of a succession of elongate members may pass to be grouped together thereby.

Where said apparatus is intended to be used to coil a large number of wires the apparatus preferably includes segregating means for segregating the coiled wires into groups. For example, where the coiled wires are to be connected to the pins of a multipin connector, (e.g. an aerospace connector which can have 100 or more pins with wires attached), the coiled wires may be segregated according to the location of the pins in the multipin connector; e.g. the wires for the innermost dozen or so pins of the connector may be grouped in a first group, the wires for a next outer series of pins be grouped in a second group and so on. Preferably, said segregator means comprises means for depositing in use a divider member into the pan means on top of a group of elongate flexible members.

In this aspect, the pan means may comprise a cylindrical wall portion and the abutment surface is defined by a plate means extending inwardly from the inner surface of said wall portion, and extending in the trailing direction with respect to rotation of the pan, thereby to define a blind channel into which the leading ends of each of a succession of elongate flexible members pass to be grouped together, but which does not prevent coiling of said elongate flexible members on subsequent turns of said pan means.

The invention also extends to marking apparatus for marking a succession of elongate flexible elements, which includes coiling apparatus as described above.

In another aspect, there is provided a method of collecting in coiled form a plurality of successive elongate flexible elements such as e.g. a wire of fibre paid out in an eject direction from an upstream location, which comprises:

providing a rotary coiling member mounted for rotation about an axis and having location means for locating said elongate flexible elements such that respective one ends thereof are grouped at a preset location with respect to said rotary coiling member;

moving said rotary coiling member to a home position such that the location means is aligned with said eject direction;

paying out said elongate member to enter said location means;

rotating said rotary coiling member whilst paying out said elongate flexible member to coil said elongate flexible member thereon;

cutting said elongate flexible member;

thereafter stopping said rotary coiling member, and

returning said rotary coiling member to its home position.

Whilst the invention has been described above, it extends to any inventive combination of the features set out above or in the following description.

The invention may be performed in various ways, and, by way of example only, an embodiment thereof will now be described in detail, reference being made to the accompanying drawings, in which:

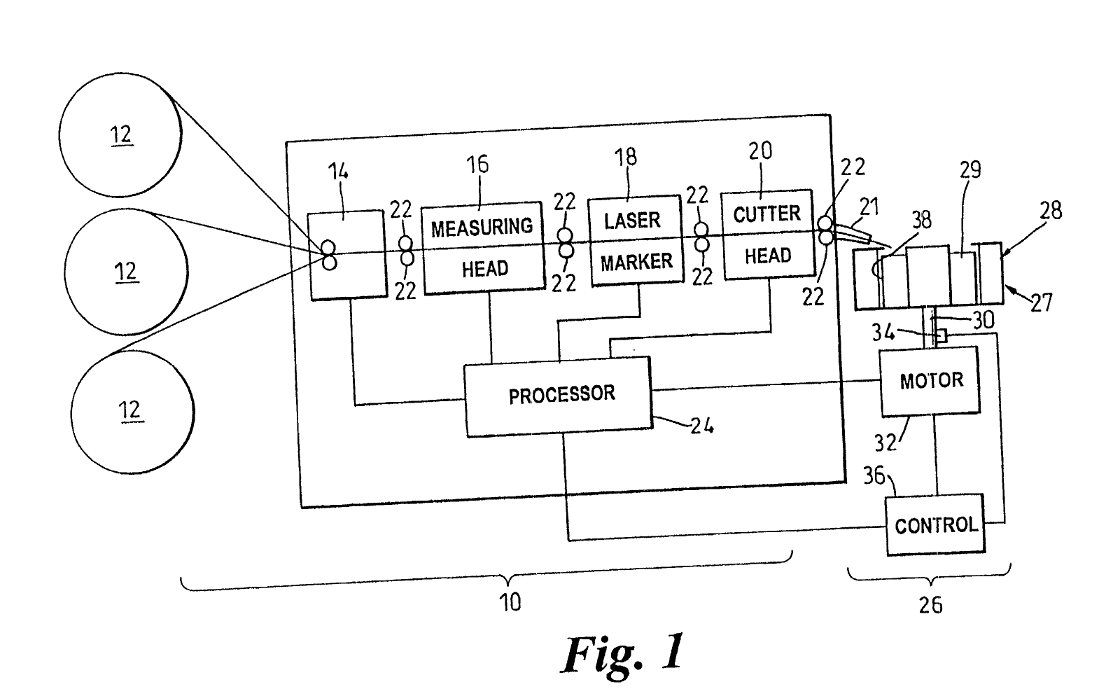

FIG. 1 is a schematic view of a laser marking apparatus for marking wires making up an electrical wiring harness, in accordance with this invention;

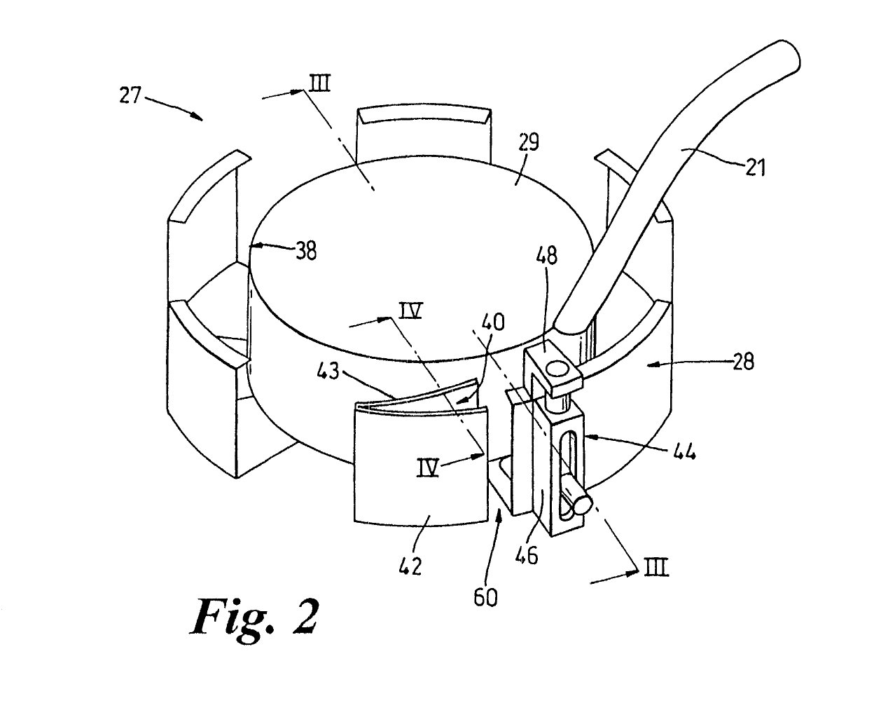

FIG. 2 is a perspective view of the rotary coiling pan and mandrel used in the apparatus of FIG. 1 but with the secondary clamp not shown;

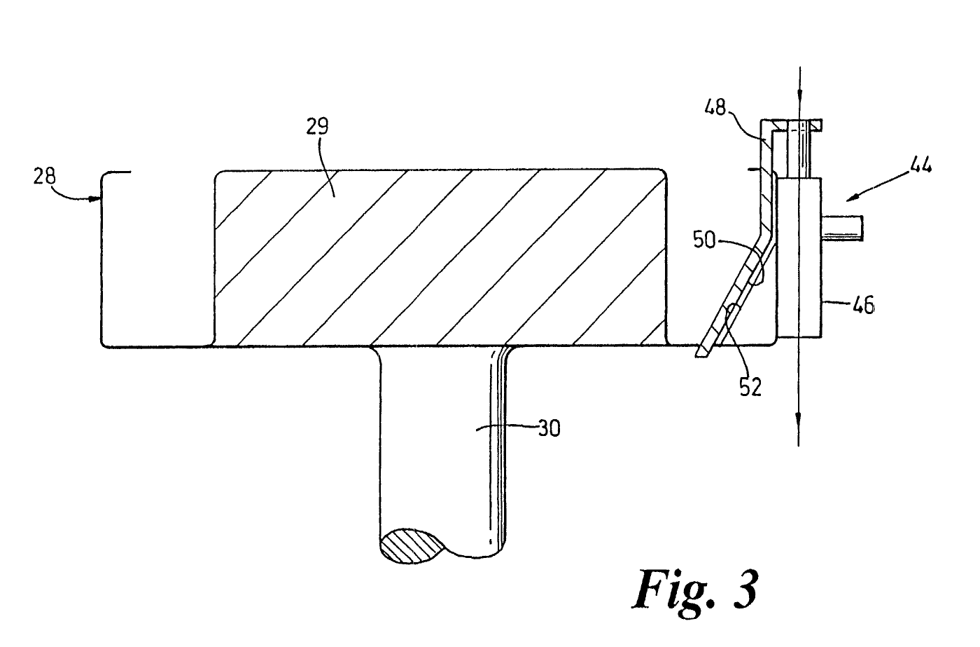

FIG. 3 is a cross-section view of the coiling pan and mandrel taken on lines III-III, showing the primary clamp, and

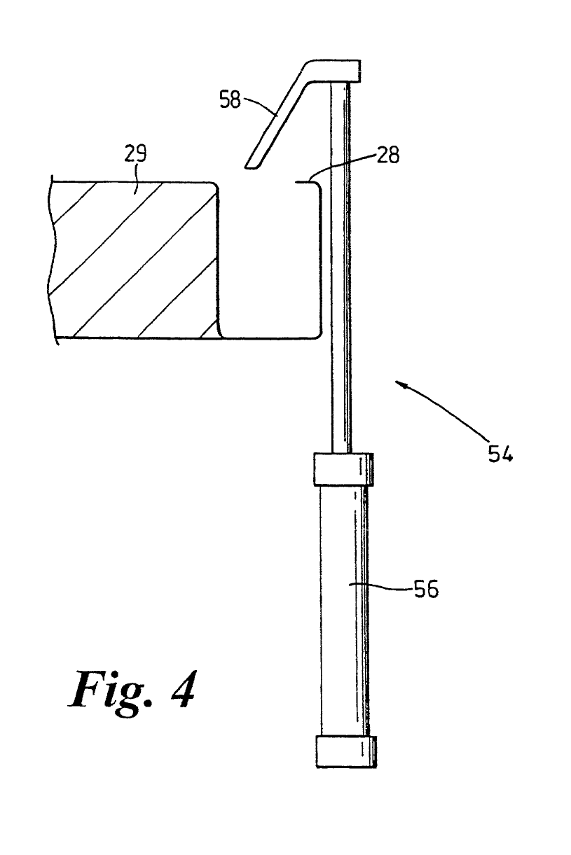

FIG. 4 is a cross-section view of a part of the coiling pan and mandrel of FIGS. 2 and 3 taken on lines IV-IV, showing the secondary clamp.

Referring initially to FIG. 1, the laser marking apparatus 10 is illustrated schematically and may take many different forms. In this particular embodiment, the apparatus takes wire from one of a bank of reels 12, as selected by a reel selector 14. The selected wire then passes through a measuring head 16 which measures the wire length. The measured wire then passes to a marking head 18 where it is marked as required, for example by a laser, ink jet printer etc. The marked and measured wire then passes to a cutting head 20 where it is cut to length. The wire is carried through the machine and paid out through an eject spout 21, by a transport mechanism 22. The reel selector 14, the marking head 16, the measuring head 18, the cutter head 20 and the wire transport mechanism 22 are all controlled by means of a processor 24. The laser marking apparatus 10 is controlled by the processor 24 to process wires by connector, so that a succession of wires of different gauge, length and marking are produced in accordance with a required connector.

Downstream of the marking apparatus 10, the wire passes into a coiling and collection device 26. This comprises an assembly 27 comprising a rotary coiling pan 28 and a mandrel 29 (to be described in greater detail below) which is rotated at an angular speed slightly greater than the linear speed of the wire entering the coiling pan and mandrel assembly. The coiling pan 28 and mandrel 29 are rotationally fixed with respect to each other and the assembly 27 thereof is mounted on a rotary shaft 30 and is driven by a motor 32 in a torque mode. The rotary shaft 30 on which the pan 28 is mounted has a rotary position sensor 34 associated with it which supplies signals to a motor controller 36, which is under control of the processor 24 so that the assembly can be brought to an angular “home” position when required.

Referring to FIGS. 2 and 3, the assembly 27 comprises a generally cylindrical mandrel 29 onto which in use wire is coiled under a tension determined by the torque setting of the motor 32. Surrounding the mandrel 29 is the segmented coiling pan 28 which constrains the trailing ends of the wires after they have been cut. The segmented nature of the coiling pan 28 facilitates access to the mandrel 29 to remove coils of wire therefore on completion of coiling of a group of wires.

The assembly 27 includes a generally tangentially facing blind collection channel 40 made up of a wall section 42 cylindrically aligned with the wall sections making up the coiling pan 28 and an arcuate tongue portion 44 secured to the wall portion 42, to define a narrowing gap into which the leading edge of a wire fed from the eject spout 21 may be lodged.

A primary clamp arrangement 44 is mounted on one of the sections making up the coiling pan 28 and comprises a vertically operating fluid-operated ram 46 and a clamping arm 48 with an inwardly inclined clamp face 50 which cooperates with a similarly inclined clamp surface 52 on an inner facing wall of the coiling pan.

The primary clamp arrangement 44 rotates with the assembly 27 and retains the leading edges of the wires in registration in the blind collection channel 40.

A secondary clamp arrangement 54 (FIG. 4) is located to one side of the assembly 27 and mounted on a fixed structure. The secondary clamp arrangement comprises a vertically operating fluid-operated ram 56 and a clamping arm 58 which when raised is clear of the assembly 27, allowing the latter to rotate, but which when lowered moves vertically through the slot 60 between the wall section 42 and the wall section adjacent the primary clamp arrangement 44 to engage and clamp the wires which extend across the slot 60 to the blind collection channel 40.

In use, the system is first initialised by operating the processor to drive the motor 32 to return the assembly 27 to the home position shown in FIG. 2, in which the assembly is positioned such that the eject spout 21 is pointing at the blind collection channel 40. The primary clamp arrangement 44 is released and moved upwardly. The feed mechanism 22 is operated to feed a first wire through the spout 21 to lodge in the blind collection channel 40, and after a predetermined feed the primary clamp arrangement 44 is operated to clamp the wire between the clamp face 50 and the clamp surface 52. The motor 32 is then energised to apply a predetermined torque to the coiling assembly 27. The wire is then marked at 18 and measured at 16 in the usual way and coiled on the mandrel 29 as it is rotated by the motor 32. Once the required length has been paid out, it is cut by the cutting head 18 and the coiling assembly 27 completes one revolution to remove the processed wire from the eject spout 21.

The trailing end of the wire will fall into the annular void between the mandrel and the coiling pan. The coiling assembly 27 will then be returned to its home position. The secondary clamp arrangement 56 is then applied to clamp the leading end region wire adjacent the primary clamp arrangement 46 and the primary clamp arrangement released so that the leading edge of the second wire can be directed into the blind collection channel 40 from the eject spout 21. The primary clamp 46 is reapplied and the secondary clamp 56 is then released and moved out of the way, and the coiling process repeated.

After the appropriate number of wires has been processed, the machine will stop, and the primary clamp arrangement released to allow the operator to remove the coils of wire from the coiling assembly 27 with all the leading ends of the wires together. The coiled wires can then be tied, e.g. with a twist tie system, and the grouped wires transferred to a bag or box.

Instead of wrapping the wires around a mandrel as shown in the Figures, the wires could be coiled in a pan similar to that shown in the Figures, but without the mandrel. If required the coils may be segregated by dropping in disc shaped segregators into the pan from a dispenser on completion of each coil.

1. A coiling apparatus for collecting in coiled form a plurality of successive elongate flexible elements, such as e.g. a wire or fibre, paid out from an upstream location, said coiling apparatus comprising a rotary coiling member mounted for rotation about an axis and adapted in use to receive a succession of said elongate flexible members and to rotate to cause each of said elongate flexible members to be coiled within or about said rotary coiling member, said rotary coiling member including location means for locating said elongate flexible elements such that respective one ends thereof are grouped at a preset location with respect to said rotary coiling member.

2. A coiling apparatus according to claim 1, wherein said location means is arranged to locate respective leading ends of the wires at said preset location with respect to the rotary coiling member.

3. A coiling apparatus according to claim 2, wherein said location means comprises an abutment surface or collection region disposed within the rotary coiling member against or into which in use the leading ends of successive elongate flexible elements engage on approaching the rotary coiling member.

4. A coiling apparatus according to an of claims 1 to 3, wherein said rotary coiling member comprises a mandrel means around which in use said flexible elements may be coiled.

5. A coiling apparatus according to claim 4, wherein said rotary coiling member further comprises a coiling pan means arranged generally concentrically with respect to said mandrel means to define therewith a substantially annular void within which in use said flexible elements may coil and the trailing ends of the flexible elements be retained.

6. A coiling apparatus according to claim 5, wherein said coiling pan means comprises a plurality of wall sections defining an interrupted generally cylindrical wall.

7. A coiling apparatus according to claim 5 or claim 6, wherein said coiling pan means is rotationally fixed with respect to said mandrel means.

8. A coiling apparatus according to any of claims 5 o 7, wherein said location means is associated with the coiling pan means.

9. A coiling apparatus according to claim 3 or any claim dependent thereon, which further includes means for ensuring in use that, for each elongate flexible element, the abutment surface or collection region is in a substantially aligned position to receive the leading end thereof as it passes into the pan means.

10. A coiling apparatus according to claim 9, including means for moving the pan means into angular registration with a datum before the leading end enters the pan means.

11. A coiling apparatus according to any of the preceding claims which includes drive means for rotating said rotary coiling member to effect coiling in use of said elongate flexible elements.

12. A coiling apparatus according to claim 11, wherein said drive means is operable to apply a limited torque to said rotary coiling member, thereby to allow slippage of the rotary coiling member relative to said drive means.

13. A coiling apparatus according to any of the preceding claims, which further includes first clamp means operable to clamp the elongate flexible elements at or adjacent their respective one ends at said present location with respect to said rotary coiling member.

14. A coiling apparatus according to claim 13, wherein said first clamp means is fixed with respect to said rotary coiling member and rotates therewith.

15. A coiling apparatus according to claim 13 or claim 14, which includes a relatively fixed further clamp means which remains rotationally stationary on rotation of said rotary coiling member and which is operable to clamp the elongate flexible elements at or adjacent their respective one end regions during a loading routine when the rotary coiling member is stationary and the first clamp means is released.

16. A coiling apparatus according to claim 3, wherein said rotary coiling member comprises a coiling pan means.

17. A coiling apparatus according to claim 16, wherein the apparatus includes segregating means for segregating the coiled elongate flexible elements into groups of one or more.

18. A coiling apparatus according to claim 17, wherein said segregating means comprises means for depositing in use a divider member into the pan means on top of a group of elongate flexible members.

19. A coiling apparatus according to any of the preceding claims, wherein said location means comprises wall surfaces defining a blind channel into which the leading ends of each of a succession of elongate members may pass to be grouped together thereby.

20. A marking apparatus for marking a succession of elongate flexible elements, which includes coiling apparatus according to any of the preceding claims.

21. A method of collecting in coiled form a plurality of successive elongate flexible elements such as e.g. a wire or fibre paid out in an eject direction from an upstream location, which comprises:
providing a rotary coiling member mounted for rotation about an axis and having location means for locating said elongate flexible elements such that respective one ends thereof are grouped at a preset location with respect to said rotary coiling member;
moving said rotary coiling member to a home position such that the location means is aligned with said eject direction;
paying out said elongate member to enter said location means;
rotating said rotary coiling member whilst paying out said elongate flexible member to coil said elongate flexible member thereon;
cutting said elongate flexible member;
thereafter cutting said elongate flexible member, and
returning said rotary coiling member to its home position.
